(19) United States
(12) Patent Application Publication
(10) Pub. No.: US 2004/0218874 A1
(43) Pub. Date: Nov. 4, 2004

(54) Fiber optic transceiver module, manufacturing method thereof, and electronic equipment

(75) Inventor: Takayuki Kondo, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/778,543

(22) Filed: Feb. 17, 2004

(30) Foreign Application Priority Data
Feb. 28, 2003 (JP) 2003-053916

(51) Int. Cl. G02B 6/26

(52) U.S. Cl. 385/88

(57) ABSTRACT

The present invention provides a fiber optic transceiver module to optically and precisely couple a light emitting or receiving element and an optical fiber that is manufactured in a short time and at a low cost, a manufacturing method thereof, and electronic equipment. The fiber optic transceiver module according to the invention includes a block that includes an optical waveguide and a guide that is provided at one end of the optical waveguide and is a concave portion into which an optical fiber is inserted, and a micro tile-like element that includes a light emitting element or a light receiving element and is attached to the block so as to have a light emitting part of the light emitting element or a light receiving part of the light receiving element facing the other end of the optical waveguide.

### BACKGROUND OF THE INVENTION

1. Field of Invention

The present invention relates to a fiber optic transceiver module to optically couple a light emitting element or a light receiving element and an optical fiber, a manufacturing method thereof, and electronic equipment.

2. Description of Related Art

Optical fibers are used in optical communications systems for transmitting laser beams and establishing communications. At the end of each optical fiber, a related art module for optical communications, that includes a light emitting element or a light receiving element, is installed. In installing this module, for example, the light emitting element, a lens, and the end of a core of the optical fiber are precisely aligned in three dimensions so as to efficiently lead light emerging from the light emitting element to the core of the optical fiber.

### SUMMARY OF THE INVENTION

Since the above-mentioned related art module for optical communications requires the precise alignment among a light emitting or receiving element, a lens, and the end of a core of an optical fiber under the condition that each of these elements is possibly out of alignment in three dimensions, installing the module is a time and cost consuming process. More precisely, in order to install the module, a light emitting element, a lens, and an optical fiber are first roughly aligned. Then, light is emerged from the light emitting element. Subsequently, the alignment among the light emitting element, the lens, and the end of the optical fiber is finely adjusted in three dimensions so as to have the light focused on the lens and launched into the end of the optical fiber.

In consideration of the and/or other problems, the invention provides a fiber optic transceiver module to optically and precisely couple a light emitting or receiving element and an optical fiber that is manufactured by a low time and cost consuming process, a manufacturing method thereof, and electronic equipment.

In order to address or achieve the above, a fiber optic transceiver module of the invention includes a block that includes an optical waveguide and a guide that is provided at one end of the optical waveguide, the guide defining a concave portion into which an optical fiber is inserted, and a micro tile-like element that includes a light emitting element or a light receiving element and is attached to the block so as to have a light emitting part of a light emitting element or a light receiving part of a light receiving element facing the other end of the optical waveguide.

According to the invention, it is possible to fix an end of the optical fiber to a predetermined position of the block by only inserting the end of the optical fiber into the guide included in the block. The other end of the optical waveguide included in the block is at a side or bottom of the guide. Therefore, it is possible to have the other end of the optical waveguide facing an end of a core of the optical fiber inserted into the guide. Consequently, it is possible to optically couple the core of the optical fiber and the optical waveguide included in the block by only inserting an end of the optical fiber into the guide. Also, as a light emitting or receiving element of the micro tile-like element attached to the block faces the other end of the optical waveguide, the light emitting or receiving element is optically coupled with the optical waveguide. This makes it possible to optically couple the light emitting or receiving element and the optical fiber by only inserting an end of the optical fiber into the guide. Also, since the invention requires no part for supporting the optical fiber such as a sleeve and a ferrule, it is possible to economically provide a fiber optic transceiver module that is compact in size.

In the fiber optic transceiver module of the invention, it is preferable that the guide and the optical waveguide are provided so that an end of a core of an optical fiber inserted into the guide faces one end of the optical waveguide.

According to the invention, it is possible to accurately align an end of the optical waveguide to the core of the optical fiber by only inserting an end of the optical fiber into the guide included in the block. The micro tile-like element including a light emitting or receiving element is attached to a surface of the block on an end of the optical waveguide, for example. Since the micro tile-like element is aligned in a two-dimensional space, a light emitting or receiving part of the light emitting or receiving element is easily aligned to the end of the optical waveguide. This alignment can be performed much more easily and accurately than the alignment performed in related art methods that align an optical fiber, a light emitting element, and a lens in three dimensions. Therefore, according to the invention, it is possible to optically couple an optical fiber and a light emitting or receiving element easily and accurately. Moreover, since the light emitting or receiving element is included in the micro tile-like element, it is possible to economically provide the fiber optic transceiver module that is significantly compact in size.

In the fiber optic transceiver module of the invention, it is preferable that the optical waveguide is provided so that a light emitting or receiving part of a light emitting or receiving element of the micro tile-like element is optically coupled to an optical fiber inserted into the guide.

This makes it possible to optically couple the optical fiber and the light emitting or receiving element with high efficiency only by inserting an end of the optical fiber into the guide included in the block.

In the fiber optic transceiver module of the invention, it is preferable that the optical waveguide is tapered.

By having a light emitting element or a core of an optical fiber facing a wider end of the optical waveguide that is tapered, it is possible to transmit light emitted by the light emitting element or the optical fiber to an intended position while reducing the need for the alignment accuracy of the light emitting element or the optical fiber. This makes it possible to optically couple the light emitting or receiving element and the optical fiber easily and effectively.

Also in the fiber optic transceiver module of the invention, when the micro tile-like element includes a light emitting element, it is preferable that the optical waveguide becomes narrower from the side of the micro tile-like element to the side of the guide in a tapered shape.

By having a wider end of the optical waveguide facing the light emitting element, it is possible to optically couple the light emitting element and the optical fiber with high efficiency while reducing the need for the alignment accuracy of the light emitting element in the block.

Also in the fiber optic transceiver module of the invention, when the micro tile-like element includes a light receiving element, it is preferable that the optical waveguide is extended from the side of the micro tile-like element to the side of the guide in a tapered shape.

By having a wider end of the optical waveguide facing a core of an optical fiber, it is possible to optically couple the light receiving element and the optical fiber with high efficiency while reducing the need for the alignment accuracy of the core of the optical fiber to the block.

Also in the fiber optic transceiver module of the invention, it is preferable that the optical waveguide is forked into passages at whose end a micro tile-like element is attached. Each micro tile-like element includes a light emitting element that emits light of a different wavelength each other.

This enables each of the lights of different wavelengths emitted by a plurality of light emitting elements to enter each of the passages. The lights are integrated in the optical waveguide and emerged from a terminal of the optical waveguide. Then, the integrated light enters a core of an optical fiber. Therefore, it is possible to easily and accurately form the fiber optic transceiver module that is an output part of a multiple-wavelength transmission device.

Also, in the fiber optic transceiver module of the invention, it is preferable that the micro tile-like element includes a plurality of micro tile-like elements each having a light emitting element that emits light of a different wavelength each other is attached to the block so that a light emitting part of each of the plurality of micro tile-like elements faces an end of the optical waveguide.

By having all light emitting parts of the plurality of micro tile-like elements facing a wider end of the optical waveguide that is tapered, it is possible to integrate lights of different wavelengths emitted by the plurality of light emitting elements in the optical waveguide and then to make the integrated light enter a core of an optical fiber. Therefore, it is possible to more easily and accurately form the fiber optic transceiver module that is an output part of a multiple-wavelength transmission device.

Also, in the fiber optic transceiver module of the invention, it is preferable that the optical waveguide includes a first member that is stick shaped and has a low refractive index and a second member that covers a boundary surface, other than an end surface, of the first member and has a high refractive index.

According to the invention, the block and the optical waveguide can be formed by using a related art method of manufacturing an optical fiber. Therefore, it is possible to more easily and economically form the fiber optic transceiver module that provides high accuracy.

In the fiber optic transceiver module of the invention, it is preferable that a boundary surface, other than an end surface, of the optical waveguide is covered with a metallic reflective coating.

This makes it possible to select the material and manufacturing process of the block and the optical waveguide, etc., from a wider range of members and methods.

In the fiber optic transceiver module of the invention, it is preferable that the optical waveguide is bent.

This enables a light emitting or receiving element and the guide to be positioned more freely. Therefore, it is possible to easily form the fiber optic transceiver module that is suitable for various kinds of devices.

Also, in the fiber optic transceiver module of the invention, it is preferable that the block is provided with an integrated circuit (IC) chip at least having a light receiving device that faces a light emitting element included in the micro tile-like element.

For example, when using a surface emitting laser as the light emitting element, the light emitting element emits light that is incident on the optical waveguide and light that is incident on the light receiving device included in the IC chip. This enables the light receiving measures to detect the amount of light emitted by the light emitting element.

Also, in the fiber optic transceiver module of the invention, it is preferable that the light receiving device detects the amount of light emitted by the light emitting element and performs a function as a detector of an auto power control circuit that controls the amount of light based on the detected amount.

This makes it easy to form the fiber optic transceiver module that is capable of the auto power control of the amount of light emitted by the light emitted element and is significantly compact in size. Consequently, it is possible to economically provide the fiber optic transceiver module that outputs optical signals corresponding to the intended amount of light emission stably for a long period of time without being adversely affected by changes in temperatures, deterioration from age, and production quality levels and is compact in size.

Also, in the fiber optic transceiver module of the invention, it is preferable that the IC chip includes an auto power control circuit that controls the amount of light emitted by the light emitting element based on the amount detected by the light receiving device.

Consequently, it is possible to economically provide the fiber optic transceiver module that outputs optical signals corresponding to the intended amount of light emission stably for a long period of time and is compact in size.

Also, in the fiber optic transceiver module of the invention, it is preferable that the IC chip includes a driver circuit that drives the light emitting element based on an output of the auto power control circuit.

Consequently, it is possible to more economically provide the fiber optic transceiver module that outputs optical signals corresponding to the intended amount of light emission stably for a long period of time and is compact in size.

In the fiber optic transceiver module of the invention, it is preferable that the light receiving device is a photodiode or a phototransistor.

In the fiber optic transceiver module of the invention, it is preferable that the photodiode is a metal-semiconductor-metal (MSM) photodiode.

The MSM photodiode has a simple configuration and is easy to be integrated with an amplifier transistor. Therefore, it is possible to economically provide the fiber optic transceiver module that is significantly compact in size and provides advanced functions.

Also, in the fiber optic transceiver module of the invention, it is preferable that the IC chip is flip-chip mounted on the block.

Therefore, there is a gap between the light emitting element and the light receiving means (the IC chip). This makes it possible to reduce or prevent the light emitting element (the micro tile-like element) from being damaged resulting from contact between the light emitting element and the light receiving device.

In the fiber optic transceiver module of the invention, it is preferable that the optical waveguide is forked in three dimensions.

A plurality of passages of the optical waveguide can be densely located. At each end of the passages, a light emitting or receiving element of the micro tile-like element is provided. Therefore, it is possible to form the fiber optic transceiver module that is used for advanced wavelength multiplexing (several dozen or more) and is significantly compact in size.

Also, in the fiber optic transceiver module of the invention, it is preferable that either an optical fiber, a ferrule or a sleeve attached to an optical fiber is inserted into the guide.

This makes it possible to optically couple the optical fiber and a light emitting or receiving element easily and accurately only by inserting an optical fiber or a ferrule or a sleeve attached to an optical fiber into the guide.

A method of manufacturing a fiber optic transceiver module of the invention includes: forming a block that includes an optical waveguide and a guide that is provided at one end of the optical waveguide and into which an optical fiber is inserted, and attaching a micro tile-like element that includes a light emitting or receiving element to the block on a side facing the other end of the optical waveguide.

This method easily provides the fiber optic transceiver module in which an end of the optical fiber is accurately fixed to a predetermined position of the block only by inserting an end of the optical fiber into the guide included in the block.

In the method of manufacturing a fiber optic transceiver module of the invention, it is preferable that the block is formed by stacking a plurality of plate members, and the optical waveguide is formed by providing a groove with at least one of the plurality of plate members and filling the groove with a transparent member.

This makes it possible to accurately and easily form the fiber optic transceiver module without perforation by combining the plurality of plate members.

Also in the method of manufacturing a fiber optic transceiver module of the invention, it is preferable that the guide is formed by providing a cutting with a plate member provided with the groove and at least another plate member out of the plurality of plate members.

By forming a cutting in at least one of the plate members and combining the plate members, it is possible to easily manufacture the fiber optic transceiver module including the guide.

Electronic equipment of the invention includes the fiber optic transceiver module.

The invention provides electronic equipment that optically couples a light emitting or receiving element and an optical fiber accurately and is compact in size. In other words, the invention economically provides electronic equipment that sends and receives optical signals and is compact in size.

### BRIEF DESCRIPTION OF THE DRAWINGS

FIG. 1 is a sectional view showing a fiber optic transceiver module of a first exemplary embodiment of the invention;

FIG. 2 is a sectional view showing a second exemplary embodiment of the invention;

FIG. 3 is a sectional view showing another example of the second exemplary embodiment of the invention;

FIG. 4 is a sectional view showing a third exemplary embodiment of the invention;

FIG. 5 is a sectional view showing another example of the third exemplary embodiment of the invention;

FIG. 6 is a sectional view showing a fourth exemplary embodiment of the invention;

FIG. 7 is a sectional view showing a fifth exemplary embodiment of the invention;

FIG. 8 is a sectional view showing a sixth exemplary embodiment of the invention;

FIG. 9 is a perspective view showing a method of manufacturing the fiber optic transceiver module of the exemplary embodiments of the invention;

FIG. 10 is an exploded perspective view of the fiber optic transceiver module;

FIGS. 11A, 11B and 11C are schematics showing the fiber optic transceiver module from three directions;

FIG. 12 is a perspective view showing a first stage of a method of manufacturing the fiber optic transceiver module;

FIG. 13 is a perspective view showing a second stage of the method of manufacturing the fiber optic transceiver module;

FIG. 14 is a perspective view showing a third stage of the method of manufacturing the fiber optic transceiver module;

FIG. 15 is a perspective view showing a fourth stage of the method of manufacturing the fiber optic transceiver module;

FIG. 16 is a perspective view showing a fifth stage of the method of manufacturing the fiber optic transceiver module;

FIG. 17 is a sectional view showing a first stage of a method of manufacturing the micro tile-like element described in the exemplary embodiments;

FIG. 18 is a perspective view showing a second stage of the method of manufacturing the micro tile-like element;

FIG. 19 is a perspective view showing a third stage of the method of manufacturing the micro tile-like element;

FIG. 20 is a perspective view showing a fourth stage of the method of manufacturing the micro tile-like element;

FIG. 21 is a perspective view showing a fifth stage of the method of manufacturing the micro tile-like element;

FIG. 22 is a perspective view showing a sixth stage of the method of manufacturing the micro tile-like element;

FIG. 23 is a perspective view showing a seventh stage of the method of manufacturing the micro tile-like element;

FIG. 24 is a perspective view showing an eighth stage of the method of manufacturing the micro tile-like element;

FIG. 25 is a perspective view showing a ninth stage of the method of manufacturing the micro tile-like element;

FIG. 26 is a perspective view showing an eleventh stage of the method of manufacturing the micro tile-like element;

FIG. 27 is a schematic showing an example of electronic equipment according to one exemplary embodiment of the invention;

FIG. 28 is a schematic showing an example of electronic equipment according to one exemplary embodiment of the invention; and

FIG. 29 is a schematic showing an example of electronic equipment according to one exemplary embodiment of the invention.

### DETAILED DESCRIPTION OF PREFERRED EMBODIMENTS

The fiber optic transceiver module according to the invention is described below by referring to the accompanying drawings.

First Exemplary Embodiment

FIG. 1 is a sectional view showing a fiber optic transceiver module and an optical fiber that is coupled to the module of a first exemplary embodiment of the invention. A fiber optic transceiver module 10 of this exemplary embodiment includes a block 11 having an optical waveguide 12 and a guide 13, and a micro tile-like element 1 that is directly attached to the block 11.

The micro tile-like element 1 includes a light emitting element or a light receiving element, for example. The micro tile-like element 1 is a minute semiconductor device whose shape is like a tile (plate). It is, for example, square in shape and from 1 to 20 micrometers deep and from several dozen to several hundred micrometers long and wide. A method of manufacturing and attaching this micro tile-like element will be described in detail below. The shape of the micro tile-like element is not necessarily limited to square and may be formed in other shapes.

Examples of the light emitting element included in the micro tile-like element 1 include a surface-emitting laser and an end-emitting laser LED. Examples of the light receiving element included in the micro tile-like element 1 include a photodiode and a phototransistor. Examples of the photodiode may include a PIN photodiode, an avalanche photodiode (APD), and a metal-semiconductor-metal (MSM) photodiode, depending on its application. The APD provides high optical sensitivity and responsive frequency range. The MSM photodiode has a simple configuration and is easy to be integrated with an amplifier transistor. The optical waveguide 12 is made of an optically transmissive member (any of a solid, liquid, or gas) and penetrates the block 11.

The guide 13 is provided at one end of the optical waveguide 12 included in the block 11. The micro tile-like element 1 is provided so that a light emitting or receiving part of the micro tile-like element 1 faces the other end of the optical waveguide 12 (a face on a side 14 of the block 11). The position of the micro tile-like element is preferably adjusted by aligning the center of the light emitting or receiving part to the center of the other end of the optical waveguide 12. If the micro tile-like element 1 includes a light emitting element and the surface of the other end of the optical waveguide 12 overlaps the light emitting part of the light emitting element, the light emitting element and a core 22 of an optical fiber is coupled with high optical coupling efficiency. If the micro tile-like element 1 includes a light receiving element and the light receiving part of the light receiving element covers the whole surface of the other end of the optical waveguide 12, the light receiving element and the core 22 of the optical fiber is coupled with high optical coupling efficiency.

The alignment between the micro tile-like element 1 and the other end of the optical waveguide 12 may be done by adjusting the position of the micro tile-like element 1 in two dimensions defined by the x and y axes on the side 14 of the block 11. Therefore, in this exemplary embodiment, there is no need to make the alignment of a light emitting or receiving element in three dimensions defined by the x, y, and z axes, and to make the alignment by driving the light emitting or receiving element, which is the case with the conventional module for optical communications. This makes it possible to make the alignment of the light emitting or receiving element more easily and promptly than related art methods.

In the block 11, the guide 13 and the optical waveguide 12 are provided so as to face an end of the core 22 of the optical fiber that is inserted into the guide 13. Preferably, the concave surface of the guide 13 has a circular section, and its diameter is almost the same as or a little greater than the diameter of the end of an optical fiber 20 including a clad 21. Moreover, the center of the core 22 of the optical fiber that is inserted into the guide is aligned to the center of one end of the optical waveguide 12. This enables the optical waveguide 12 and the core 22 of the optical fiber 20 to be coupled with high optical coupling efficiency only by inserting an end of the optical fiber 20 into the guide 13. In other words, the core 22 of the optical fiber 20 and a light emitting or receiving element of the micro tile-like element 1 are coupled with high optical coupling efficiency only by inserting an end of the optical fiber 20 into the guide 13.

If the micro tile-like element 1 includes a light emitting element and the surface of the end of the core 22 of the optical fiber overlaps the surface of one end of the optical waveguide 12, the light emitting element and the core 22 is coupled with high optical coupling efficiency. If the micro tile-like element 1 includes a light receiving element and the surface of one end of the optical waveguide 12 overlaps the surface of the end of the core 22 of the optical fiber, the light receiving element and the core 22 is coupled with high optical coupling efficiency.

Second Exemplary Embodiment

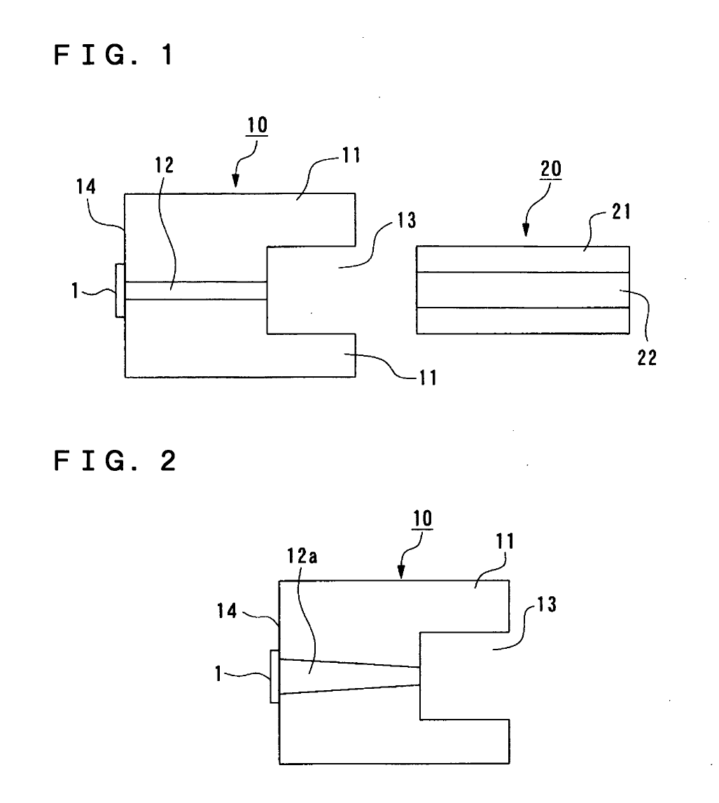

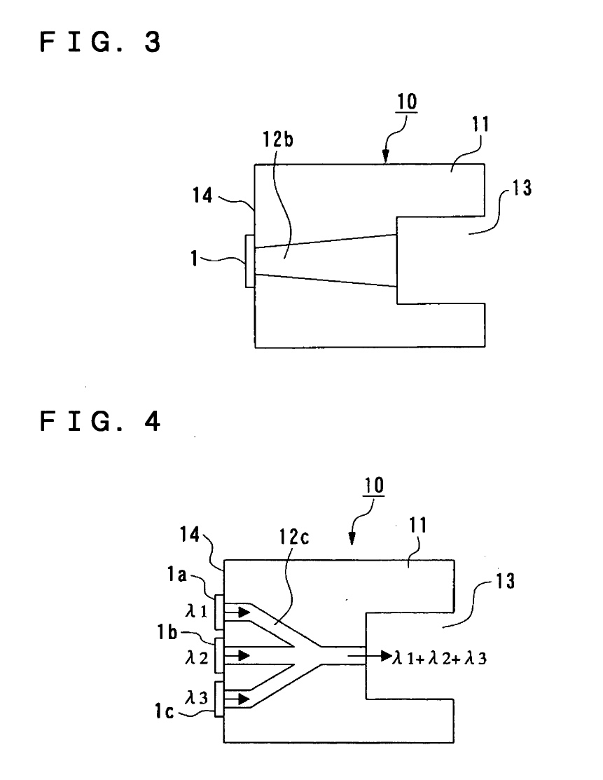

A second exemplary embodiment of the invention is described below by referring to FIGS. 2 and 3. FIG. 2 is a sectional view showing a fiber optic transceiver module of the second exemplary embodiment of the invention. FIG. 3 is a sectional view showing another example of this exemplary embodiment. This exemplary embodiment is different from the first exemplary embodiment in that an optical waveguide 12a and an optical waveguide 12b in the fiber optic transceiver module 10 of this exemplary embodiment are tapered. By making the optical waveguides 12a and 12b tapered, it is possible to optically couple a light emitting or receiving element and the optical fiber 20 with high efficiency, while reducing the need for the alignment accuracy of the micro tile-like element 1 and the form accuracy of the guide 13.

As for the fiber optic transceiver module 10 shown in FIG. 2, the micro tile-like element 1 preferably includes a light emitting element. The optical waveguide 12a becomes narrower from the side of the micro tile-like element 1 to the side of the guide 13 in a tapered shape. With this configuration, since the wider end of the optical waveguide 12a faces the light emitting element of the micro tile-like element 1, the optical waveguide 12a focuses light emitted by the light emitting element on an intended area (that is, the end of the core 22 of the optical fiber 20). Thus, the optical waveguide 12a performs the same function as a lens. According to this exemplary embodiment, therefore, it is possible to optically couple a light emitting element and the core 22 of the optical fiber 20 with high efficiency, while reducing the need for the alignment accuracy of the light emitting element, the form accuracy of the guide 13, and the insertion alignment accuracy of the optical fiber 20 to the guide 13.

As for the fiber optic transceiver module 10 shown in FIG. 3, the micro tile-like element 1 preferably includes a light receiving element. The optical waveguide 12b is extended from the side of the micro tile-like element 1 to the side of the guide 13 in a tapered shape. With this configuration, since the wider end of the optical waveguide 12b faces the end of the core 22 of the optical fiber 20, the optical waveguide 12b focuses light emitted from the core 22 on an intended area (that is, the light receiving part of the micro tile-like element 1). Thus, the optical waveguide 12b performs the same function as a lens. According to this embodiment, therefore, it is possible to optically couple a light receiving element and the optical fiber 20 with high efficiency, while reducing the need for the alignment accuracy of the end of the core 22 of the optical fiber 20 to the block 11.

Third Exemplary Embodiment

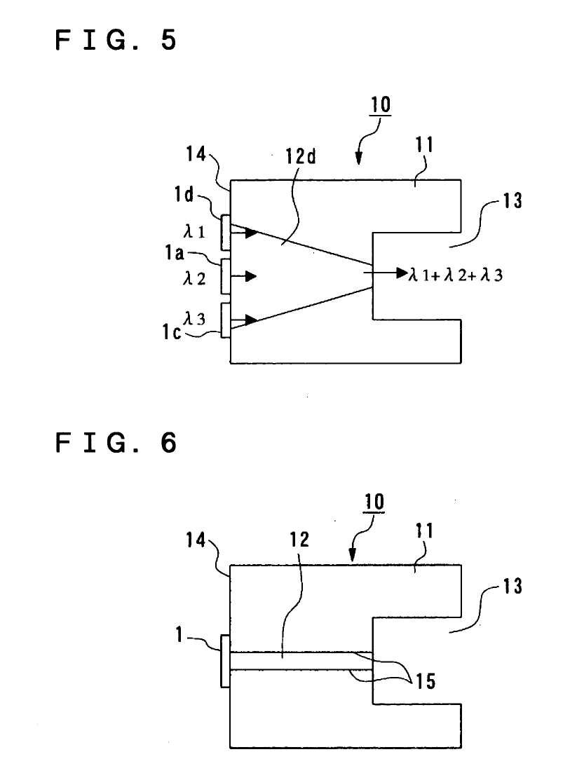

A third exemplary embodiment of the invention is described below by referring to FIGS. 4 and 5. FIG. 4 is a sectional view showing a fiber optic transceiver module of the third exemplary embodiment of the invention. FIG. 5 is a sectional view showing another example of this exemplary embodiment. The fiber optic transceiver module 10 of this exemplary embodiment is used for wavelength multiplexing.

As for the fiber optic transceiver module 10 shown in FIG. 4, an optical waveguide 12c is forked into three passages. Micro tile-like elements 1a, 1b, and 1c are attached to the side 14 of the block 11 so as to face each end of the passages. The micro tile-like elements 1a, 1b, and 1c are provided with a light emitting element that emits light of wavelengths λ1, λ2, and λ3, respectively.

Lights of wavelengths λ1, λ2, and λ3 emitted by the micro tile-like elements 1a, 1b, and 1c, respectively, are integrated in the optical waveguide 12c, and the integrated light enters the core 22 of the optical fiber 20 inserted into the guide 13. According to this exemplary embodiment, therefore, it is possible to easily and accurately form the fiber optic transceiver module 10 that is an output part of a multiple-wavelength transmission device. The optical waveguide 12c is not always forked into three passages. The optical waveguide 12c may be a forked waveguide that is forked into several dozens of passages. Moreover, the passages can be placed not only in a virtual two-dimensional space as shown in FIG. 4, but also in a three-dimensional space. By attaching the micro tile-like element 1 to the end of each passage, it is possible to easily and accurately form the fiber optic transceiver module 10 that is used for advanced wavelength multiplexing and is compact in size.

As for the fiber optic transceiver module 10 shown in FIG. 5, a plurality of the micro tile-like elements 1a, 1b, and 1c are attached to the side 14 of the block 11. The micro tile-like elements 1a, 1b, and 1c are provided with a light emitting element that emits light of wavelengths λ1, λ2, and λ3, respectively. An optical waveguide 12d is extended to the side of the micro tile-like elements 1a, 1b, and 1c in a tapered shape. The light emitting part of each of the micro tile-like elements 1a, 1b, and 1c is provided so as to face the wider end of the optical waveguide 12d.

Lights of wavelengths λ1, λ2, and λ3 emitted by the micro tile-like elements 1a, 1b, and 1c, respectively, are integrated in the optical waveguide 12d, and the integrated light enters the core 22 of the optical fiber 20 inserted into the guide 13. According to this exemplary embodiment, therefore, it is possible to easily and accurately form the fiber optic transceiver module 10 that is an output part of a multiple-wavelength transmission device. The number of micro tile-like elements that are provided so as to face the wider end of the optical waveguide 12d is not limited to three. Several dozens of micro tile-like elements each emitting light of different wavelengths may be provided so as to face the wider end of the optical waveguide 12d. Thus, it is possible to easily and accurately form the fiber optic transceiver module 10 that is used for advanced wavelength multiplexing and is compact in size.

Fourth Exemplary Embodiment

A fourth exemplary embodiment of the invention is described below by referring to FIGS. 1 and 6. FIG. 6 is a sectional view showing a fiber optic transceiver module of the fourth exemplary embodiment of the invention. The optical waveguide 12 is made of, for example, a member that has a high refractive index, while the block 11 that covers the optical waveguide 12 is made of a member that has a low refractive index. With this configuration like relationship between a core and a clad of an optical fiber, light entering the optical waveguide 12 (made of the member of a high refractive index) is totally reflected between the member of a high refractive index and the member of a low refractive member, and thereby is transmitted through the optical waveguide 12 almost without attenuation.

As for the fiber optic transceiver module 10 shown in FIG. 6, a boundary surface, other than an end surface, of the optical waveguide 12 is covered with a metallic reflective coating 15. The metallic reflective coating 15 is formed by a metallic coating process, for example. The inside of the metallic reflective coating 15 may be hollow or filled with a transparent member whose refractive index is not specified. This makes it possible to select the material of the block 11 and the optical waveguide 12 from a wider range of members.

Fifth Exemplary Embodiment

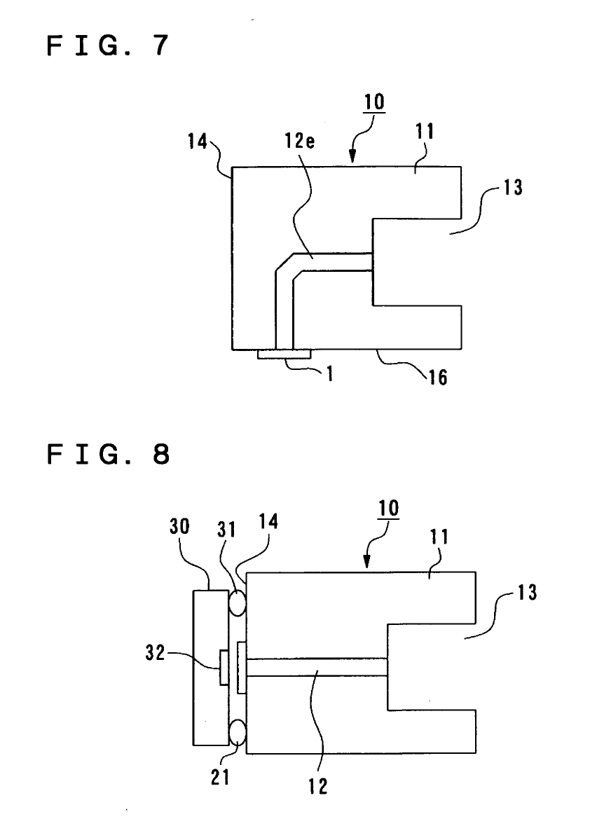

A fifth exemplary embodiment of the invention is described below by referring to FIG. 7. FIG. 7 is a sectional view showing a fiber optic transceiver module of the fifth exemplary embodiment of the invention. An optical waveguide 12e included in the fiber optic transceiver module 10 shown in FIG. 7 is bent about 90 degrees. The micro tile-like element 1 is provided so as to face an end of the optical waveguide 12e (a face in parallel with the bottom of the block 1) that is bent.

This makes it possible to reduce the need for the alignment accuracy of the micro tile-like element 1 and the form accuracy of the guide 13. According to this exemplary embodiment, therefore, it is possible to easily form the fiber optic transceiver module 10 that is suitable for various kinds of devices.

Sixth Exemplary Embodiment

A sixth exemplary embodiment of the invention is described below by referring to FIG. 8. FIG. 8 is a sectional view showing a fiber optic transceiver module of the sixth exemplary embodiment of the invention. The fiber optic transceiver module 10 of this exemplary embodiment is different from the aforementioned exemplary embodiments in that an integrated circuit (IC) chip 30 is flip-chip mounted on the block 11. The IC chip 30 is flip-chip mounted so as to face the side 14 of the block 11 via a bump 31. Therefore, there is a gap between the IC chip 30 and the side 14 of the block 11.

The IC chip 30 includes a light receiving device 32 having a photodiode or a phototransistor. The micro tile-like element 1 that is attached to the side 14 of the block includes a light emitting element. The light emitting element is preferably a surface emitting laser. The IC chip 30 is flip-chip mounted so that the light receiving device 32 of the IC chip 30 faces a light emitting part of the micro tile-like element.

The light emitting element (e.g., a surface emitting laser) included in the micro tile-like element 1 emits a laser beam to the light receiving device 32 of the IC chip 30 as well as to the optical waveguide 12. This enables the light receiving device 32 to detect the amount of light emitted by the light emitting element included in the micro tile-like element 1. The IC chip 30 preferably includes an auto power control (APC) circuit that controls the amount of light emitted by the light emitting element of the micro tile-like element 1 based on the amount detected by the light receiving device 32. The IC chip 30 also preferably includes a driver circuit that outputs power for driving the light emitting element of the micro tile-like element 1 by amplifying signals output by the APC circuit. The output of the driver circuit is transmitted to the light emitting element of the micro tile-like element 1 via the bump 31.

This exemplary embodiment makes it easy to form the fiber optic transceiver module 10 that is capable of the auto power control of the amount of light emitted by the light emitted element (e.g., a surface emitting laser) included in the micro tile-like element 1 and is compact in size. Consequently, it is possible to economically provide the fiber optic transceiver module 10 that outputs optical signals corresponding to the intended amount of light emission stably for a long period of time without being adversely affected by changes in temperatures, aged deterioration, and production quality levels and is compact in size. Also, as the IC chip 30 is flip-chip mounted on the block 11 of this exemplary embodiment, there is a gap between the micro tile-like element 1 and the light receiving device 32. This makes it possible to reduce or prevent the micro tile-like element 1 from being damaged resulting from contact between the micro tile-like element 1 and the light receiving device 32.

Manufacturing Methods

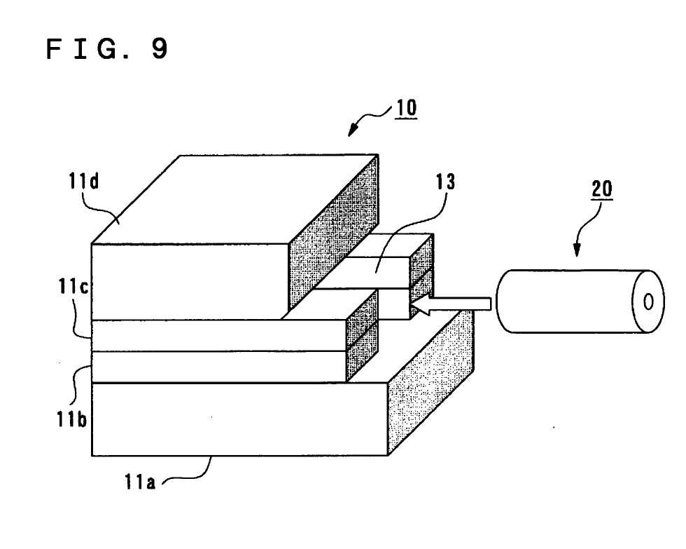

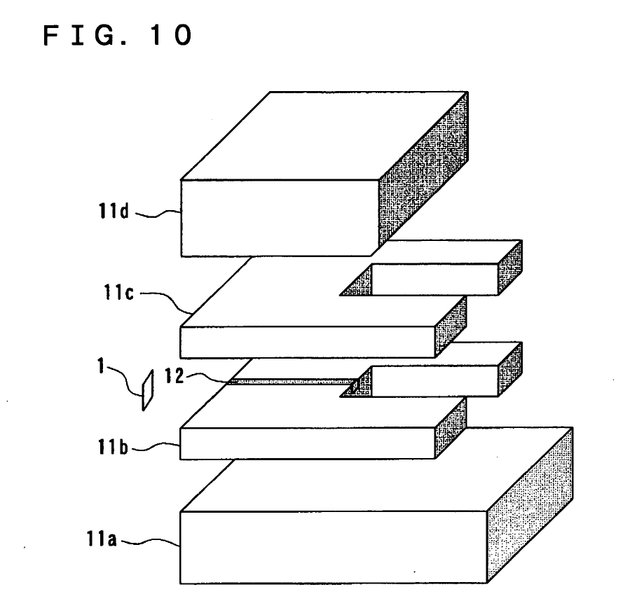

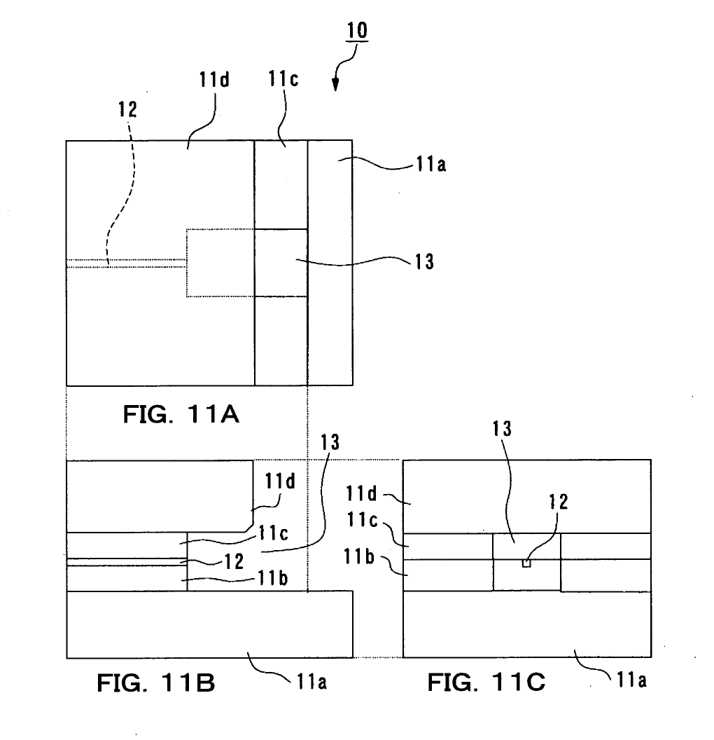

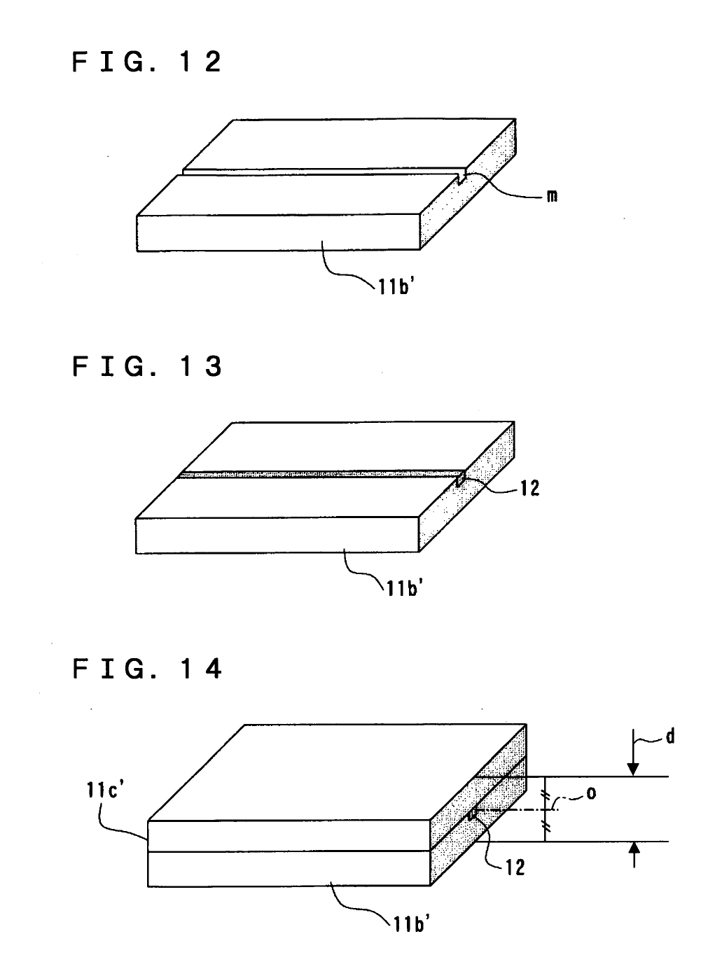

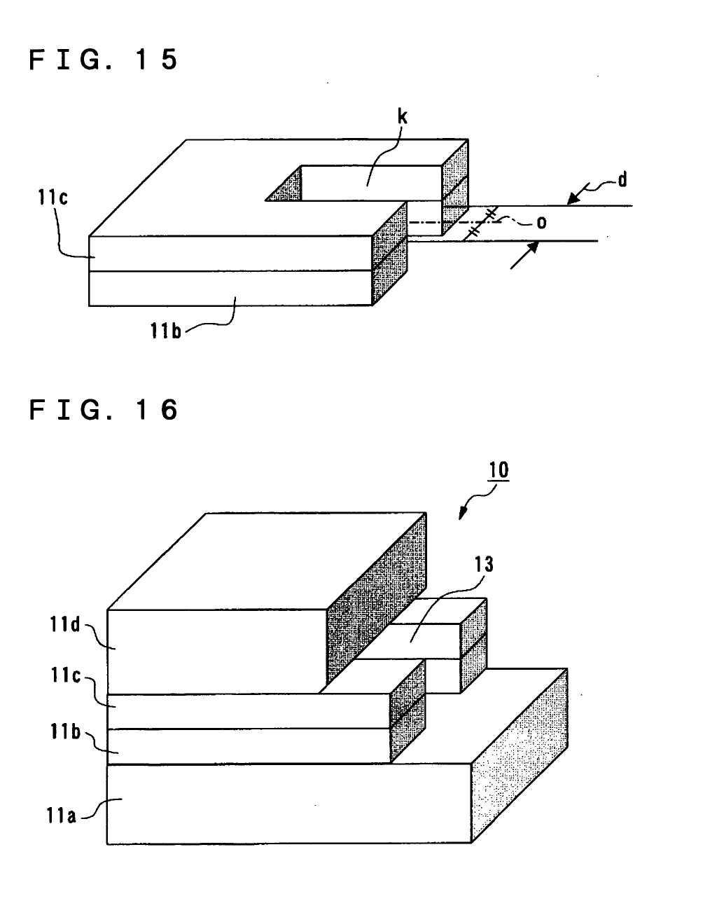

A method of manufacturing the fiber optic transceiver module described in the aforementioned exemplary embodiments is described below by referring to FIGS. 9 to 16. FIG. 9 is a perspective view showing a plurality of plate members 11a, 11b, 11c, and 11d that are stacked to form the block 11 included in the fiber optic transceiver module 10 described in the exemplary embodiments. FIG. 10 is an exploded perspective view of the fiber optic transceiver module 10 shown in FIG. 9. FIG. 1A is a plan view showing the fiber optic transceiver module 10 shown in FIG. 9. FIG. 1B is a center section view and FIG. 11C is a front view of the fiber optic transceiver module 10 shown in FIG. 9.

As shown in these figures, the guide 13 of the fiber optic transceiver module 10 includes concave parts of the plate members 11b and 11c. The plate member 11b is provided with the optical waveguide 12. The optical waveguide 12 is square-pole-shaped and is buried in the plate member 11b so as to have the upper surface of the square pole as the upper surface of the plate member 11b. The shape of the optical waveguide 12 is not limited to a square pole. It may be circular or elliptic cylinder-shaped. The optical waveguide 12 is preferably provided so as to have the upper surface of the optical waveguide 12 as the upper surface of the plate member 11b, however, the optical waveguide 12 may be provided so as to penetrate the inside of the plate member 11b. By providing the optical waveguide 12 so as to have the upper surface of the optical waveguide 12 as the upper surface of the plate member 11b, it becomes easier to form the optical waveguide 12.

Also, the optical waveguide 12 may be provided in the plate member 11c. Alternatively, the optical waveguide 12 may be formed in a way that has one half of the optical waveguide 12 being buried in the plate member 11b and another half in the plate member 11c. This makes it easy to form the optical waveguide 12 that is cylinder-shaped.

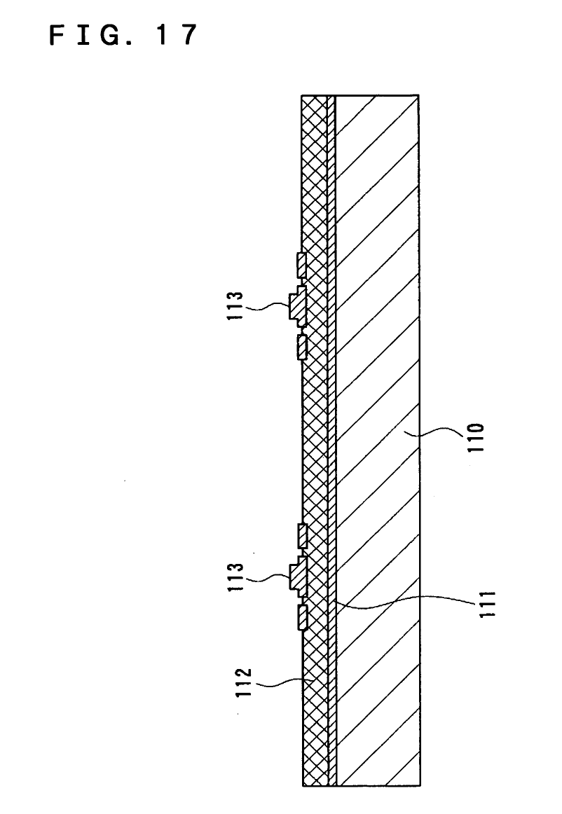

A detailed method of manufacturing the fiber optic transceiver module 10 shown in FIGS. 9 to 11 is described below by referring to FIGS. 12 to 16. FIG. 12 is a perspective view showing a first stage of the method of manufacturing the fiber optic transceiver module 10. As shown in FIG. 12, a groove (indicated by “m” in the drawing) is first formed by etching or carving on a plate 11b′. The plate 11b′having the groove “m” may be formed by using a stamper or injection molding.

The plate 11b′is a material of the plate member 11b.

FIG. 13 is a perspective view showing a second stage of the method of manufacturing the fiber optic transceiver module 10. The groove “m” is filled with resin in this stage. For example, the groove “m” is filled with ultraviolet (UV) cured liquid resin, and then the resin is cured by being exposed to UV rays.

The resin is preferably transparent and has a high refractive index, on one hand. On the other, the plate 11b′preferably has a low refractive index. The resin that fills the groove “m” is to be the optical waveguide 12.

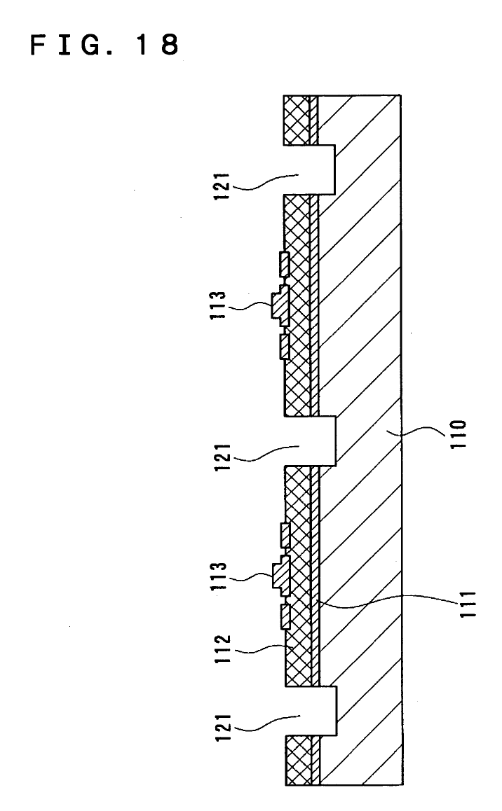

FIG. 14 is a perspective view showing a third stage of the method of manufacturing the fiber optic transceiver module 10. In this stage, a plate 11c′ is attached on top of the plate 11b′that has been processed in the first and second stages. The plate 11c′ is a material of the plate member 11c. The plate 11c′ preferably has a low refractive index.

The thickness of the plates 11b′and 11c′ meets the following requirements. First, the total thickness of the plates 11b′ and 11c′ is almost the same as or a little greater than the diameter of the optical fiber 20 that is coupled to the fiber optic transceiver module 10 or the diameter of the tip of a ferrule (a part for supporting the optical fiber) that is attached to the end of the optical fiber 20. Second, since the optical waveguide 12 is formed by attaching the plate 11c′ to the plate 11b′ having the groove “m”, the center (indicated by “O”) of the optical waveguide 12 is preferably aligned to the center of the total thickness (indicated by “d”) of the plates 11b′ and 11c′.

FIG. 15 is a perspective view showing a fourth stage of the method of manufacturing the fiber optic transceiver module 10. In this stage, the plates 11b′ and 11c′ are cut to form a cutting (indicated by “k”) as shown in FIG. 15, and thereby the plate members 11b and 11c are formed. The cutting “k” is formed by cutting or laser processing. The width “d” of the cutting “k” is almost the same as or a little greater than the diameter of the optical fiber 20 that is coupled to the fiber optic transceiver module 10 or the diameter of the tip of the ferrule.

In other words, the thickness “d” of the cutting “k” is almost the same as the total thickness “d” of the plate 11b′ (the plate member 11b) and the plate 11c′ (the plate member 11c) that is attached to the plate 11b′. The width of the cutting “k” is preferably extended to the open end in a tapered shape. Alternatively, edges of the open end of the cutting “k” may be cut off. In this way, it becomes easy to insert the optical fiber 20 into the guide 13 formed by the cutting “k”. Also, the cutting “k” is formed so as to align the center “O” of the cutting “k” to the center “O” of the optical waveguide 12 shown in FIG. 14. The bottom of the cutting “k” is made flat.

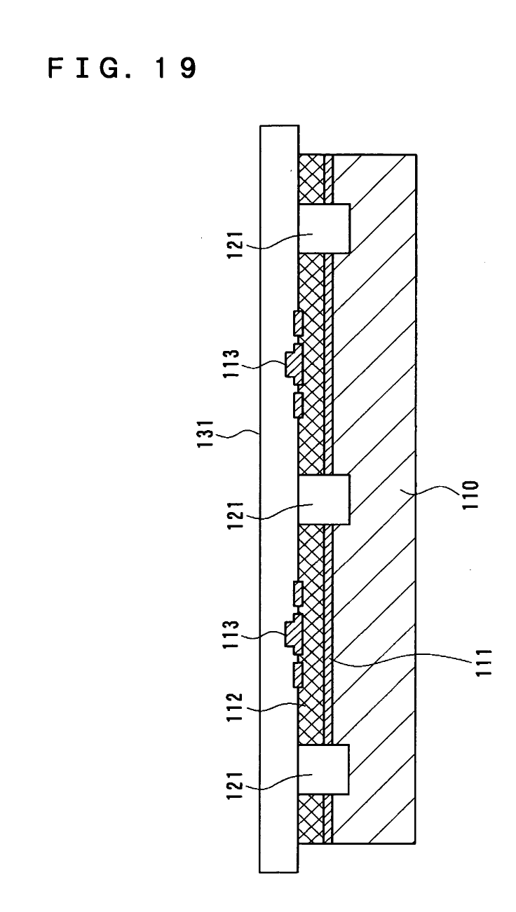

FIG. 16 is a perspective view showing a fifth stage of the method of manufacturing the fiber optic transceiver module 10. In this stage, the plate member 111a that is a flat plate is attached to the bottom of the plate member 11b and the plate member 11d that is a flat plate is attached on top of the plate member 11c as shown in FIG. 16. The right side of the plate member 11a preferably protrudes from the end of the cutting “k” formed in the plate members 11b and 11c. Also, the right side of the plate member 11d is preferably recessed from the end of the cutting “k” formed in the plate members 11b and 11c. Edges of the plate member 1d facing the cutting “k” are preferably cut off. This makes it easier to insert the optical fiber 20 into the guide 13 formed by the cutting “k”.

Thus, the block 11 having the optical waveguide 12 included in the fiber optic transceiver module 10 is formed. Subsequently, the micro tile-like element 1 is attached to a predetermined position of the block 11, which completes the fiber optic transceiver module 10 shown in FIG. 1.

According to this manufacturing method, it is possible to accurately and easily form the fiber optic transceiver module 10 without perforation by combining the plurality of plate members 11a, 11b, 11c, and 11d. Therefore, the fiber optic transceiver module 10, which optically couples the optical fiber 20 and a light emitting or receiving element of the micro tile-like element 1 attached to a predetermined position of the block 11 with high efficiency, is easily manufactured by inserting an end of the optical fiber into the guide 13 included in the block 11.

While the plate members 11b and 11c are formed by making the cutting “k” in the plates 11b′ and 11c′ at a later stage in the process, the optical waveguide 12 and the plate members 11b and 11c having the cutting “k” may be formed in one stage by injection molding, for example.

Method of Manufacturing Micro Tile-Like Element

A method of manufacturing the micro tile-like element 1 having a light emitting element or a light receiving element and a method of attaching the micro tile-like element 1 to the block 11 (a final substrate) are described below by referring to FIGS. 17 to 26. This manufacturing method is based on the epitaxial lift-off method. While an example in which a compound semiconductor device (a compound semiconductor element) as the micro tile-like element is attached on the block 11 that is a final substrate is described below, the invention can be applied to the block 11 of any type and form. Also in this exemplary embodiment, while “a semiconductor substrate” refers to a substance made of a semiconductor material, the semiconductor substrate is not limited to this and includes any semiconductor materials irrespective of their forms.

First Stage

FIG. 17 is a sectional view showing a first stage of the method of manufacturing the micro tile-like element.

Referring to FIG. 17, a substrate 110 is a semiconductor substrate, for example, a GaAs compound semiconductor substrate. The bottom layer on the substrate 110 is a sacrificial layer 111. The sacrificial layer 111 is made of AlAs and is, for example, several hundred nanometers deep.

On the sacrificial layer 111, a functional layer 112 is deposited, for example. The functional layer 112 is, for example, 1 to 10 (20) micrometers deep. On the functional layer 112, a semiconductor device (e.g. a surface emitting laser) 113 is formed. Examples of the semiconductor device 113 include a surface emitting laser (VCSEL) and a driver circuit or APC circuit using other function elements, such as a phototransistor (PD), a high electron mobility transistor (HEMT), and a heterobipolar transistor (HBT). The semiconductor device 113 is formed by an element composed of multiple epitaxial layers on the substrate 110. The semiconductor device 113 is also provided with an electrode and undergoes operational testing.

Second Stage

FIG. 18 is a sectional view showing a second stage of the method of manufacturing the micro tile-like element.

In this stage, a separate trench 121 is formed so as to separate the semiconductor device 113 from another semiconductor device. The separate trench 121 is deep enough to at least reach the sacrificial layer 111. For example, the separate trench is ten to several hundred micrometers wide and deep. Also, the separate trench 121 extends without interruption so that a selective etching liquid that is described in detail later flows in it. The separate trench 121 is preferably arranged in a grid.

By making an interval between the separate trench 121 and another separate trench from several dozen to several hundred micrometers, the size of the semiconductor device 113 that is separated by the separate trench 121 is set between several dozen to several hundred square micrometers. The separate trench 121 is formed by photolithography and the method using wet etching or dry etching. The separate trench 121 may be formed by dicing of a U-shaped trench, as long as a crack does not occur on the substrate.

Third Stage

FIG. 19 is a sectional view showing a third stage of the method of manufacturing the micro tile-like element.

In this stage, an intermediate transfer film 131 is disposed on the surface of the substrate 110 (on the side of the semiconductor device 113). The intermediate transfer film 131 is a flexible film on which an adhesive is applied.

Fourth Stage

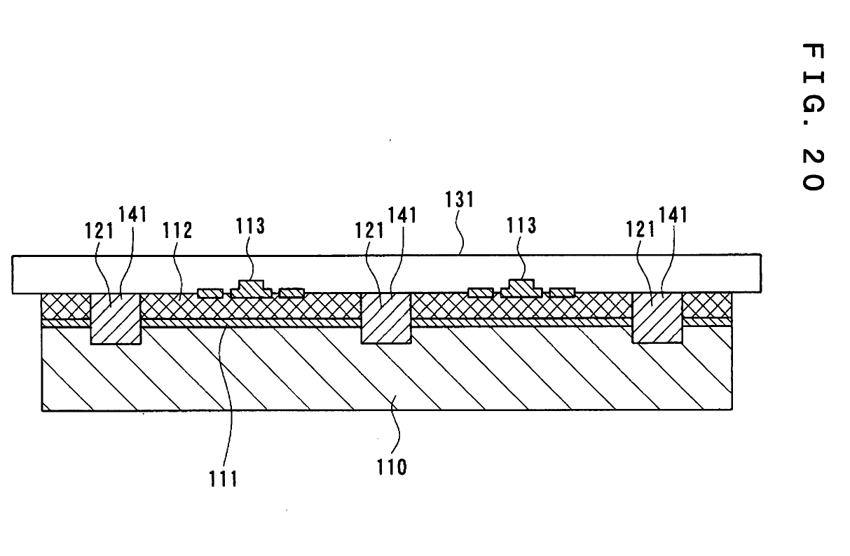

FIG. 20 is a sectional view showing a fourth stage of the method of manufacturing the micro tile-like element.

In this stage, a selective etching liquid 141 is injected into the separate trench 121. In order to selectively etch the sacrificial layer 111, low levels of hydrochloric acid, which is highly selective for aluminum and arsenic, are used as the selective etching liquid 141.

Fifth Stage

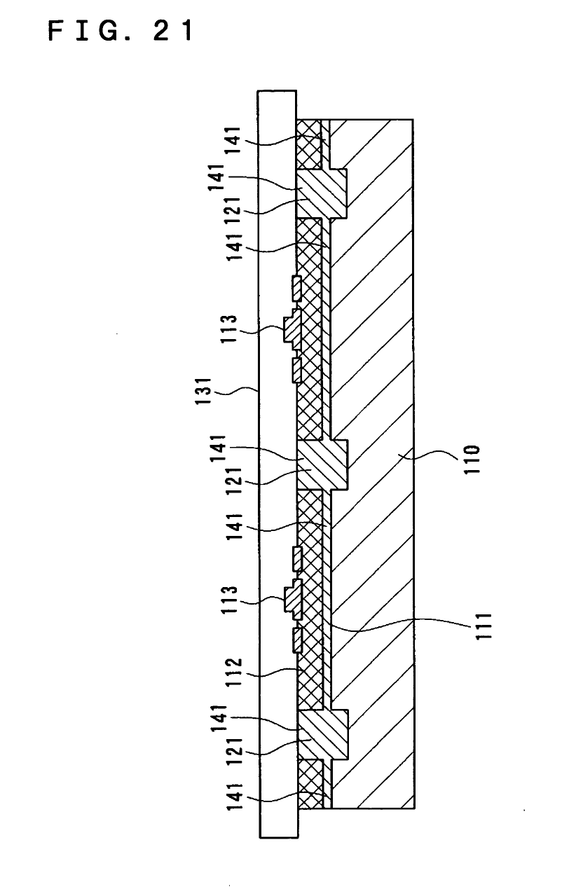

FIG. 21 is a sectional view showing a fifth stage of the method of manufacturing the micro tile-like element.

In this stage, when a predetermined period of time elapses after injecting the selective etching liquid 141 into the separate trench 121 in the fourth stage, the sacrificial layer 111 is selectively etched and then removed from the substrate 110.

Sixth Stage

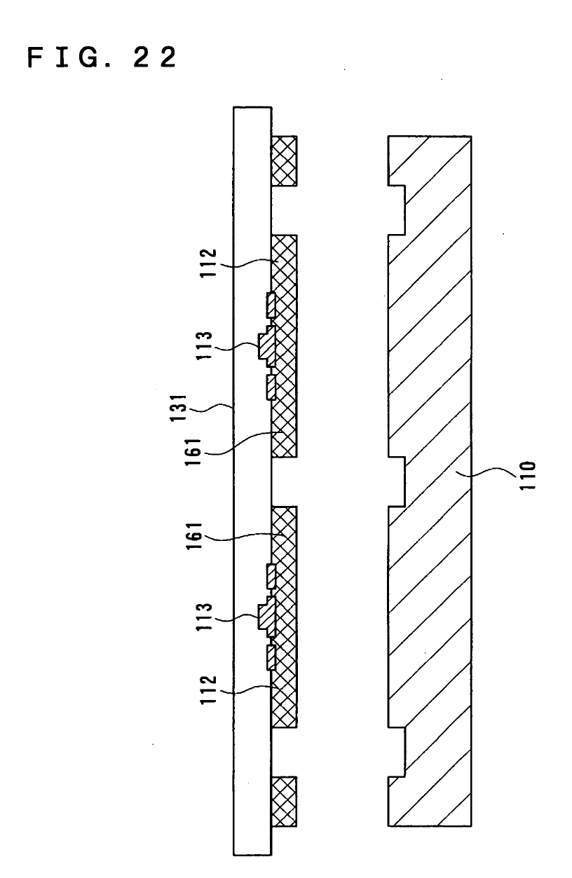

FIG. 22 is a sectional view showing a sixth stage of the method of manufacturing the micro tile-like element.

The sacrificial layer 111 is etched in the fifth stage, the functional layer 112 is separated from the substrate 110. Subsequently, the intermediate transfer film 131 is separated from the substrate 110, and thereby the functional layer 112 adhering to the intermediate transfer film 131 is separated from the substrate 110 in this stage.

Thus, the functional layer 112, on which the semiconductor device 113 is formed, is separated through the forming of the separate trench 121 and etching of the sacrificial layer 111, and thereby a micro tile-like element 161 (corresponding to the micro tile-like element 1 in the above-mentioned embodiments) of a predetermined form (e.g., a tile-like form) is formed and attached to the intermediate transfer film 131. The functional layer is preferably 1 to 10 micrometers deep and several dozen to several hundred micrometers long and wide, for example.

Seventh Stage

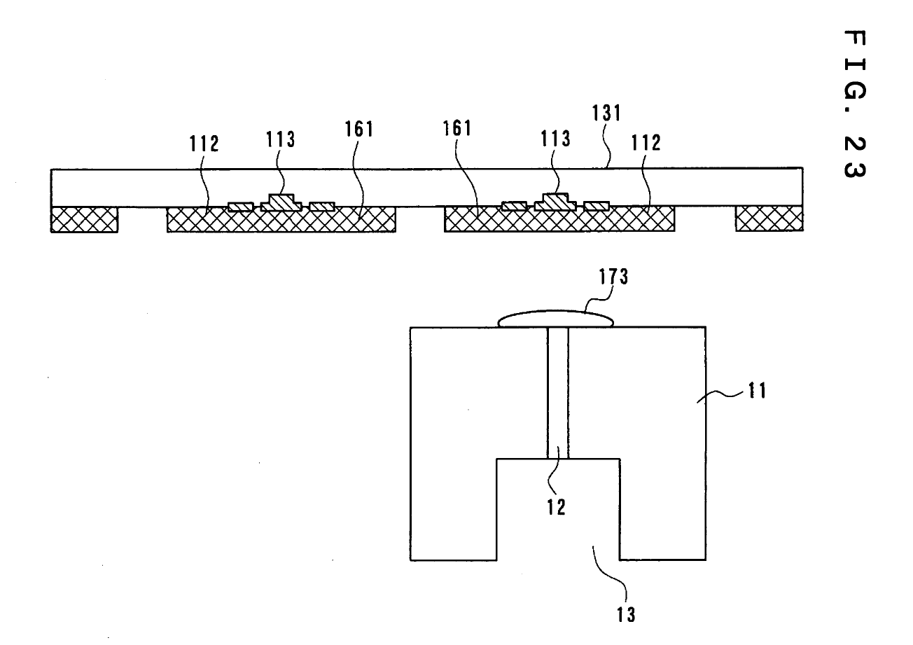

FIG. 23 is a sectional view showing a seventh stage of the method of manufacturing the micro tile-like element.

In this stage, by moving the intermediate transfer film 131, to which the micro tile-like element 161 is attached, the micro tile-like element 161 is aligned to an intended position on the block 11 that is a final substrate. On the intended position on the block 11, an adhesive 173 is applied to retain the micro tile-like element 161. Alternatively, an adhesive is applied to the micro tile-like element 161.

Eighth Stage

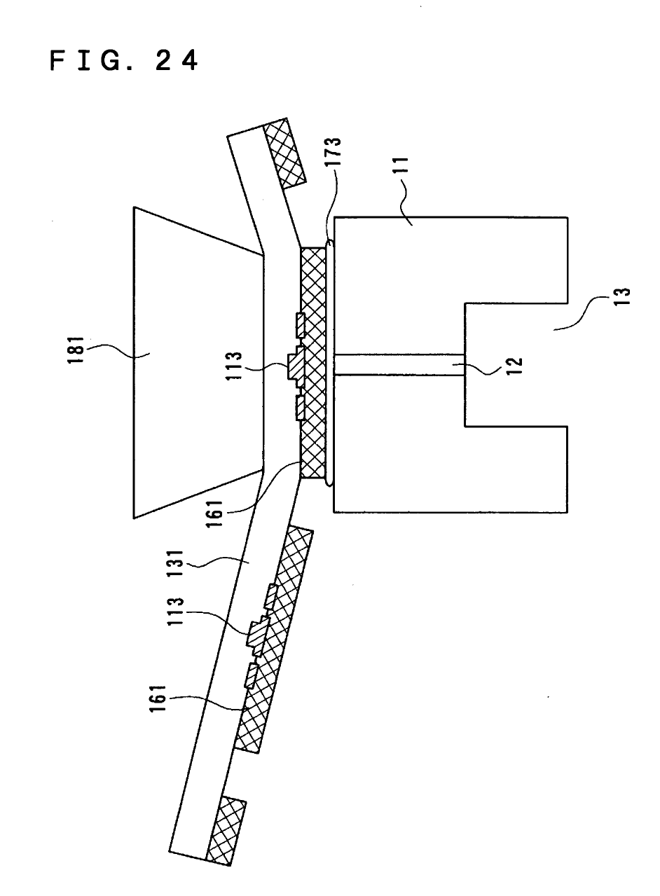

FIG. 24 is a sectional view showing an eighth stage of the method of manufacturing the micro tile-like element.

In this stage, the micro tile-like element 161 that is aligned to an intended position on the block 11 is pressed with a back pressing pin 181 via the intermediate transfer film 131 and joined to the block 11. Since the adhesive 173 is applied on the intended position, the micro tile-like element 161 is joined to the intended position on the block 11.

Ninth Stage

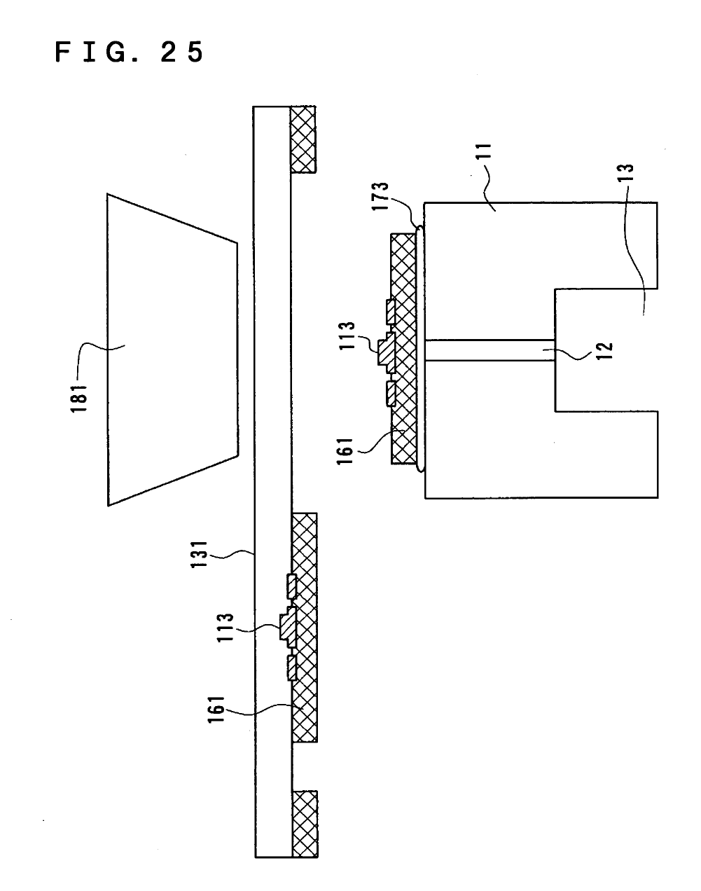

FIG. 25 is a perspective view showing a ninth stage of the method for manufacturing the micro tile-like element. In this stage, by making the intermediate transfer film 131 lose adhesion, the intermediate transfer film 131 is separated from the micro tile-like element 161.

The intermediate transfer film 131 is provided with a UV cure or thermosetting adhesive. When using a UV cure adhesive, the back pressing pin 181 used here is made of a transparent material. By exposing the back pressing pin 181 to UV rays from its end, the intermediate transfer film 131 loses adhesion. When using a thermosetting adhesive, the same effect is obtained by heating the back pressing pin 181. Alternatively, the intermediate transfer film 131 also loses adhesion by being exposed to UV rays on its entire surface after the sixth stage. While the intermediate transfer film 131 loses adhesion, it still maintains adhesion that is strong enough to retain the micro tile-like element 161, which is thin and light, on the intermediate transfer film 131.

Tenth Stage

This stage is not illustrated in the accompanying drawings. In this stage, the micro tile-like element 161 is firmly joined to the block 11 by heat treatment.

Eleventh Stage

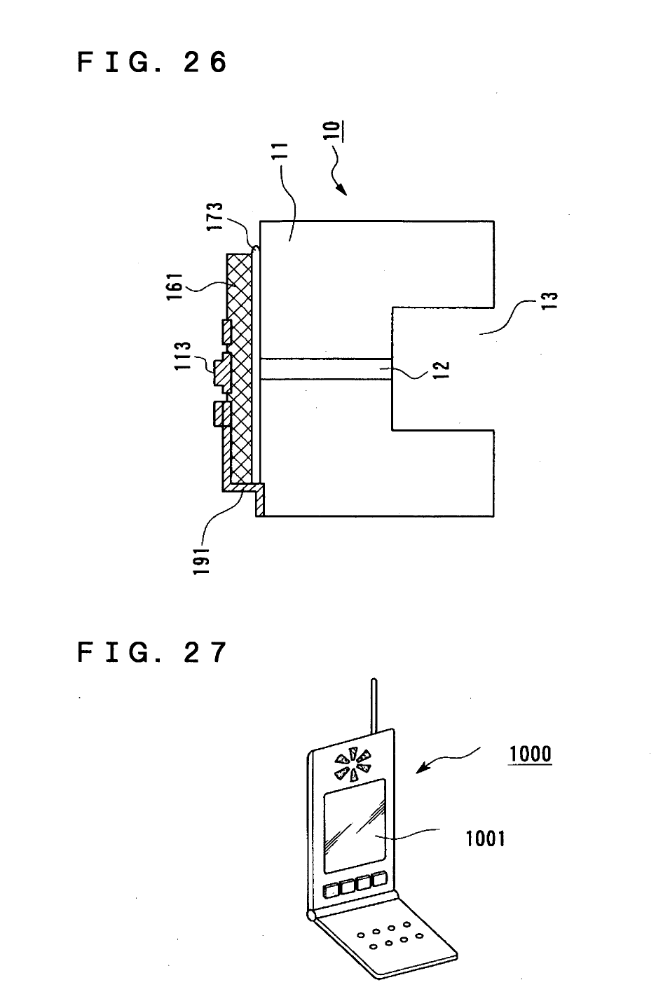

FIG. 26 is a sectional view showing an eleventh stage of the method for manufacturing the micro tile-like element. In this stage, an electrode of the micro tile-like element 161 (a light emitting or receiving element) and a circuit on the block 11 (or the IC chip 30 shown in FIG. 8) are electrically coupled by a wiring 191, which completes the fiber optic transceiver module 10. A glass substrate, a quartz substrate, and a plastic film as well as a silicon semiconductor may be used as the block 11 or the IC chip 30.

As a result, it is possible to form a semiconductor element forming a surface emitting laser, etc., on a substrate that is made of a material different from that of the semiconductor element. For example, even if the block 11 as a final substrate 171 is made of plastic, it is possible to form the micro tile-like element 161 having a GaAs surface emitting laser on an intended position on the block 11. This method also enables the selection of a surface emitting laser, etc., through testing before forming a fiber optic transceiver module, since the separation in a micro tile-like form comes after the forming of the surface emitting laser, etc., on a semiconductor substrate.

Also with this manufacturing method, only the functional layer having a semiconductor element (a light emitting or receiving element) is separated as a micro tile-like element from a semiconductor substrate and mounted on a film. Therefore, it is possible to selectively join the light emitting or receiving element to the block 11, and thereby to make the light emitting or receiving element smaller compared to one that is manufactured by conventional mounting. As a result, it is possible to easily and economically form the fiber optic transceiver module 10 that receives and emits laser beams of an intended amount and state and is compact in size.

Exemplary Electronic Equipment

Examples of electronic equipment having the fiber optic transceiver module described in the above-mentioned exemplary embodiments are described below.

FIG. 27 is a perspective view showing an example of a cellular phone. FIG. 27 shows a cellular phone 1000 having the aforementioned fiber optic transceiver module, and a display 1001.

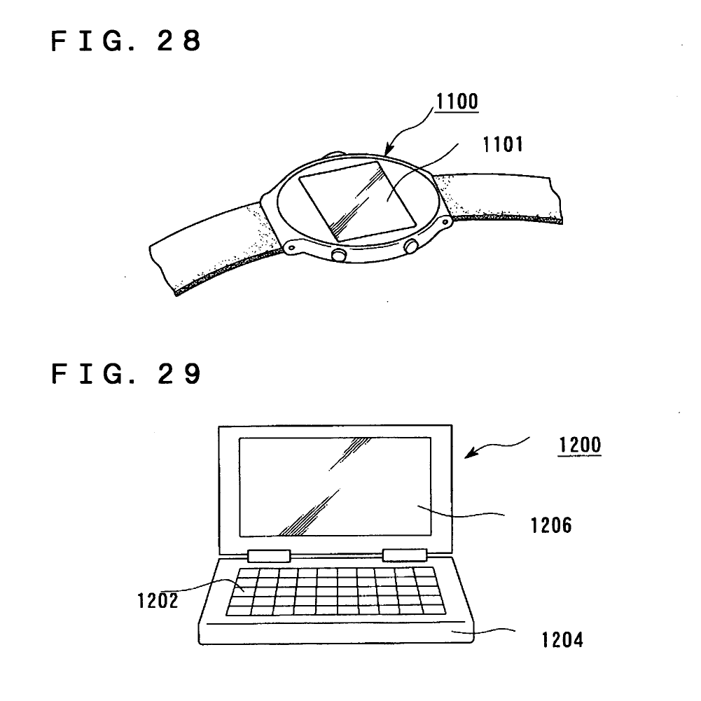

FIG. 28 is a perspective view showing an example of wristwatch electronic equipment. FIG. 28 shows a wristwatch 1100 having the aforementioned fiber optic transceiver module, and a display 1101.

FIG. 29 is a perspective view showing an example of a portable information processor, such as a word processor and a computer, for example. FIG. 29 shows an information processor 1200 having the aforementioned fiber optic transceiver module. It includes an input device 1202, such as a keyboard, a body 1204 of the information processor, and a display 1206.

Since the electronic equipment shown in FIGS. 27 to 29 include the fiber optic transceiver module described in the above-mentioned exemplary embodiments, they operate at high speeds utilizing optical signals, and can be manufactured economically.

The technical range of this invention is not limited to the above-mentioned exemplary embodiments. While this invention has been described in terms of several exemplary embodiments specifying materials and layer configuration, there are alterations and equivalents which fall within the scope of this invention.

For example, while the micro tile-like element 1 includes a light emitting element or a light receiving element in the above-mentioned exemplary embodiments, the application of the invention is not limited to this. A flip-chip element may replace the micro tile-like element 1, for example.

While an optical fiber with a ferrule is inserted into the guide 13 in the exemplary embodiments, it is also possibly to directly insert an optical fiber into the guide 13 by appropriately setting the size of the guide 13.

Alternatively, a generic sleeve may be preferably used depending on specifications of a fiber connector. In this case, it is possible to join the sleeve to the guide 13 whose size is appropriate for directly receiving the sleeve in part and automatically setting its central axis. A generic sleeve may replace the guide 13 here. In this case, the central axis of the sleeve is preferably aligned to the end of the optical waveguide 12.

What is claimed is:

1. A fiber optic transceiver module for use with an optical fiber, comprising:
a block that includes an optical waveguide and a guide provided at one end of the optical waveguide, the guide defining a concave portion into which the optical fiber is inserted; and
a micro tile-like element that includes an electro-optical element attached to the block, the electro-element having at least one of a light emitting part of a light emitting element and a light receiving part of a light receiving element facing another end of the optical waveguide.

2. The fiber optic transceiver module according to claim 1,
the guide and the optical waveguide being provided so that an end of a core of an optical fiber that is inserted into the guide faces one end of the optical waveguide.

3. The fiber optic transceiver module according to claim 1,
the optical waveguide being provided so as to optically couple the at least one of the light emitting part and the light receiving part of the electro-optical element of the micro tile-like element and the optical fiber that is inserted into the guide.

4. The fiber optic transceiver module according to claim 1,
the optical waveguide being tapered.

5. The fiber optic transceiver module according to claim 4,
the micro tile-like element including a light emitting element, and the optical waveguide becoming narrower from a side of the micro tile-like element to a side of the guide in a tapered shape.

6. The fiber optic transceiver module according to claim 4,
the micro tile-like element including a light receiving element, and the optical waveguide being extended from a side of the micro tile-like element to a side of the guide in a tapered shape.

7. The fiber optic transceiver module according to claim 1,
the optical waveguide being forked into passages defining an end, the micro tile-like elements being attached to the end, the micro tile-like elements including light emitting elements that emit light of a different wavelength from each other.

8. The fiber optic transceiver module according to claim 5,
the micro tile-like elements, each having a light emitting element that emits light of a different wavelength from each other, being attached to the block so that a light emitting part of each of the plurality of micro tile-like elements faces an end of the optical waveguide.

9. The fiber optic transceiver module according to claim 1,
the optical waveguide including a first member that is stick shaped and has a low refractive index, and a second member that covers a boundary surface, other than an end surface, of the first member and has a high refractive index.

10. The fiber optic transceiver module according to claim 1,
a boundary surface, other than an end surface, of the optical waveguide being covered with a metallic reflective coating.

11. The fiber optic transceiver module according to claim 1,
the optical waveguide being bent.

12. The fiber optic transceiver module according to claim 1,
the block being provided with an integrated circuit chip including at least a light receiving device so as to have the light receiving device facing a light emitting element of the micro tile-like element.

13. The fiber optic transceiver module according to claim 12,
the light receiving device detecting an amount of light emitted by the light emitting element and performing a function as a detector of an auto power control circuit that controls an amount of light based on the detected amount.

14. The fiber optic transceiver module according to claim 12,
the integrated circuit chip including an auto power control circuit that controls an amount of light emitted by the light emitting element based on an amount detected by the light receiving device.

15. The fiber optic transceiver module according to claim 14,
the integrated circuit chip including a driver circuit that drives the light emitting element based on an output of the auto power control circuit.

16. The fiber optic transceiver module according to claim 12,
the light receiving device being at least one of a photodiode and a phototransistor.

17. The fiber optic transceiver module according to claim 16,
the photodiode being a metal-semiconductor-metal photodiode.

18. The fiber optic transceiver module according to claim 12,
the integrated circuit chip being flip-chip mounted on the block.

19. The fiber optic transceiver module according to claim 7,
the optical waveguide being forked in three dimensions.

20. The fiber optic transceiver module according to any one of claim 1,
at least one of an optical fiber, a ferrule attached to an optical fiber, and a sleeve attached to an optical fiber being inserted into the guide.

21. A method of manufacturing a fiber optic transceiver module, comprising:
forming a block that includes an optical waveguide and a guide provided at one end of the optical waveguide, an optical fiber being insertable into the guide; and
attaching a micro tile-like element that includes an electro-optical element to the block on a side facing an other end of the optical waveguide.

22. The method of manufacturing a fiber optic transceiver module according to claim 21, further including forming the block by stacking a plurality of plate members, and forming the optical waveguide by providing a groove with at least one of the plurality of plate members and filling the groove with a transparent member.

23. The method of manufacturing a fiber optic transceiver module according to claim 22, further including forming the guide by providing a cutting with a plate member provided with the groove and at least another plate member out of the plurality of plate members.

24. Electronic equipment, comprising:
the fiber optic transceiver module according to claim 1.
